(19) United States
(12) Patent Application Publication
(10) Pub. No.: US 2012/0294515 A1
(43) Pub. Date: Nov. 22, 2012

(54) IMAGE PROCESSING APPARATUS AND IMAGE PROCESSING METHOD, LEARNING APPARATUS AND LEARNING METHOD, PROGRAM, AND RECORDING MEDIUM

(75) Inventor: Keisuke CHIDA, Tokyo (JP)

(73) Assignee: SONY CORPORATION, Tokyo (JP)

(21) Appl. No.: 13/440,032

(22) Filed: Apr. 5, 2012

(30) Foreign Application Priority Data
May 20, 2011 (JP) 2011-113059

(51) Int. Cl. G06K 9/62

(52) U.S. Cl. 382/159

(57) ABSTRACT

A predictive signal processing unit calculates a pixel value of a luminance component of a pixel of interest by a calculation of a predictive coefficient for a luminance component and a luminance prediction tap. A predictive signal processing unit calculates a pixel value of a chrominance component of a pixel of interest by a calculation of a predictive coefficient for a chrominance component which is higher in noise reduction effect than the predictive coefficient for the luminance component and a chrominance prediction tap. For example, the present technology can be applied to an image processing apparatus.

### BACKGROUND

The present technology relates to an image processing apparatus, an image processing method, a learning apparatus, a learning method, a program, and a recording medium, and more particularly, to an image processing apparatus, an image processing method, a learning apparatus, a learning method, a program, and a recording medium, which are capable of generating a low-noise image of a luminance-chrominance space from an image of a Bayer array with a high degree of accuracy.

In the past, there have been imaging devices including only one imaging element such as a charge coupled device (CCD) image sensor or a complementary metal-oxide semiconductor (CMOS) image sensor for the purpose of miniaturization. In the imaging devices, different color filters are generally employed for respective pixels of an imaging element, and so a signal of any one of a plurality of colors such as red, green, and blue (RGB) is acquired from each pixel. For example, an image acquired by an imaging element in this way becomes an image of a color array illustrated in FIG. 1. In the following, a color array of FIG. 1 is referred to as a “Bayer array.”

Typically, an image of a Bayer array acquired by an imaging element is converted into a color image in which each pixel has a pixel value of any one of a plurality of color components such as RGB by an interpolation process called a demosaicing process. It is considered to reduce noise of a color image by using a class classification adaptive process as the demosaicing process (for example, see Japanese Patent No. 4433545).

The class classification adaptive process refers to a process that classifies a pixel of interest which is a pixel attracting attention in a processed image into a predetermined class, and predicts a pixel value of the pixel of interest by linearly combining a predictive coefficient obtained by learning corresponding to the class with a pixel value of a non-processed image corresponding to the pixel of interest.

FIG. 2 is a block diagram illustrating an exemplary configuration of an image processing apparatus that performs a class classification adaptive process as a demosaicing process.

The image processing apparatus 10 of FIG. 2 includes an imaging element 11 and a predictive signal processing unit 12.

The imaging element 11 of the image processing apparatus 10 employs different color filters for respective pixels. The imaging element 11 acquires an analog signal of any one of an R component, a G component, and a B component of light from a subject for each pixel, and performs analog-to-digital (AD) conversion on the analog signal to thereby generate an image of a Bayer array. The imaging element 11 supplies the generated image of the Bayer array to the predictive signal processing unit 12.

The predictive signal processing unit 12 performs the demosaicing process on the image of the Bayer array supplied from the imaging element 11, and generates a low-noise RGB image which is a color image including pixel values of a red (R) component, a green (G) component, and a blue (B) component of respective pixels.

Specifically, the predictive signal processing unit 12 sequentially sets each of pixels of the RGB image as a pixel of interest, and classifies the pixel of interest into a predetermined class for each color component using pixel values of pixels of the image of the Bayer array around the pixel of interest. Further, the predictive signal processing unit 12 holds a predictive coefficient obtained for color component and class by a learning in which the image of the Bayer array is set as a student image and a low-noise RGB image is set as a teacher image in advance. Then, the predictive signal processing unit 12 predicts a pixel value of a pixel of interest by linearly combining a predictive coefficient corresponding to a class of a pixel of interest with pixel values of an image of a Bayer array around the pixel of interest for each color component. In this way, a low-noise RGB image is generated. The predictive signal processing unit 12 outputs the low-noise RGB image as an output image.

Meanwhile, in the class classification adaptive process in the predictive signal processing unit 12 of FIG. 2, since the predictive coefficient is obtained for each color component and class, it is difficult to adjust a degree of noise reduction in an output image in a unit other than a color component. Thus, even though a degree of noise reduction in an output image is adjusted, a degree of noise reduction in either color component is relatively strong, and when a portion other than a noise of the color component is affected, an adverse effect that a false color is generated in an edge portion occurs.

Meanwhile, there is a method of reducing a noise of a YUV image by converting an RGB image obtained as a result of the demosaicing process into an image (hereinafter, referred to as a “YUV image”) of a luminance-chrominance space and performing the class classification adaptive process on the YUV image. In this method, in terms of human visual property which is sensitive to sharpness of luminance but insensitive to sharpness of chrominance, a degree of noise reduction in a chrominance component (Cb and Cr components) is larger than a degree of noise reduction in a luminance component (Y component). Thus, since a portion other than a noise of a luminance component (Y component) is not affected even though a noise of a chrominance component of an output image is reduced, it is difficult to detect a reduction in sharpness by the eyes. In other words, a color noise can be reduced without any reduction in sharpness.

FIG. 3 is a diagram illustrating an exemplary configuration of an image processing apparatus that converts an image of a Bayer array into a low-noise YUV image using the above-mentioned method.

Among components illustrated in FIG. 3, the same components as the components illustrated in FIG. 2 are denoted by the same reference numeral. The redundant description will be appropriately omitted.

An image processing apparatus 20 of FIG. 3 includes an imaging element 11, a demosaicing processing unit 21, a luminance-chrominance converting unit 22, and predictive signal processing units 23 and 24.

The demosaicing processing unit 21 of the image processing apparatus 20 performs the demosaicing process on the image of the Bayer array generated by the imaging element 11, and supplies an RGB image obtained as the result to the luminance-chrominance converting unit 22.

The luminance-chrominance converting unit 22 performs a luminance-chrominance converting process for converting the RGB image supplied from the demosaicing processing unit 21 into a YUV image. The luminance-chrominance converting unit 22 supplies a luminance component of the YUV image obtained as the result to the predictive signal processing unit 23 and supplies the luminance component to the predictive signal processing unit 24.

The predictive signal processing unit 23 performs the class classification adaptive process on the luminance component of the YUV image supplied from the luminance-chrominance converting unit 22, and generates a luminance component of a low-noise YUV image.

Specifically, the predictive signal processing unit 23 sequentially sets each of pixels of the low-noise YUV image as a pixel of interest, and classifies a luminance component of the pixel of interest into a predetermined class using pixel values of pixels, of a YUV image before noise reduction from the luminance-chrominance converting unit 22, around the pixel of interest. Further, the predictive signal processing unit 23 holds a predictive coefficient for a luminance component obtained for each class by a learning process in which a YUV image before noise reduction is set as a student image, and a YUV image after noise reduction is set as a teacher image in advance. Then, the predictive signal processing unit 23 predicts a pixel value of a luminance component of the pixel of interest by linearly combining a predictive coefficient for a luminance component corresponding to a class of a luminance component of the pixel of interest with pixel values of the YUV image before noise reduction around the pixel of interest. As a result, a luminance component of a low-noise YUV image is generated. The predictive signal processing unit 23 outputs the luminance component of the low-noise YUV image as a luminance component of an output image.

Similarly to the predictive signal processing unit 23, the predictive signal processing unit 24 performs the class classification adaptive process on a chrominance component of the YUV image supplied from the luminance-chrominance converting unit 22 using a predictive coefficient for a chrominance component obtained for each class by a learning process. Then, the predictive signal processing unit 24 outputs the chrominance component of the low-noise YUV image generated as the result as a chrominance component of the output image.

The predictive coefficient for the luminance component and the predictive coefficient for the chrominance component are learned so that a degree of noise reduction in the chrominance component of the output image can be larger than a degree of noise reduction in the luminance component.

### SUMMARY

The image processing apparatus 20 of FIG. 3 performs three processes, that is, the demosaicing process, the luminance-chrominance converting process, and the class classification adaptive process on the image of the Bayer array. Thus, when information of a fine line portion or the like present in the image of the Bayer array is lost due to the demosaicing process or the like, the accuracy of the output image degrades.

Specifically, when information of a fine line portion or the like is lost due to the demosaicing process and so an RGB image has a flat portion, it is difficult for the luminance-chrominance converting unit 22 to recognize whether the flat portion of the RGB image is an originally existing flat portion or a flat portion caused by loss of the fine line portion. Thus, even when information of the fine line portion or the like has been lost due to the demosaicing process, the luminance-chrominance converting unit 22 converts the RGB image supplied from the demosaicing processing unit 21 into the YUV image, similarly to an RGB image in which the information of the fine line portion or the like has not been lost. As a result, an output image becomes an image corresponding to an image obtained by smoothing an image of a Bayer array that has not been subjected to the demosaicing process, and so the accuracy of the output image degrades.

Similarly, even when an edge of a color or the like which is not present in an image of a Bayer array is generated due to the demosaicing process, the accuracy of the output image degrades.

The present technology is made in light of the foregoing, and it is desirable to generate a low-noise YUV image from an image of a Bayer array with a high degree of accuracy.

According to a first embodiment of the present technology, there is provided a n image processing apparatus, including a luminance prediction calculation unit that calculates a pixel value of a luminance component of a pixel of interest that is a pixel attracting attention in a predetermined low-noise image corresponding to a predetermined image of a Bayer array, by a calculation of a predictive coefficient for a luminance component learned by solving a formula representing a relation between a pixel value of a luminance component of each pixel of a teacher image corresponding to a low-noise image which is an image including pixel values of a luminance component and a chrominance component of each pixel of the image of the Bayer array and an image having a reduced noise and the predictive coefficient for the luminance component, and a luminance prediction tap that includes a pixel value of a pixel of the predetermined image of the Bayer array using the teacher image, which corresponds to the pixel of interest, and a student image corresponding to the image of the Bayer array, and a chrominance prediction calculation unit that calculates a pixel value of a chrominance component of the pixel of interest by a calculation of a predictive coefficient for a chrominance component which is learned by solving a formula representing a relation among a pixel value of a chrominance component of each pixel of the teacher image, a pixel value of a pixel of the student image corresponding to the pixel, and the predictive coefficient for the chrominance component and a chrominance prediction tap that corresponds to the pixel of interest in the predetermined low-noise image and includes a pixel value of a pixel of the predetermined image of the Bayer array and is higher in noise reduction effect than the predictive coefficient for the luminance component using the teacher image and the student image.

The image processing method, the program, and the program recorded in the recording medium according to the first embodiment of the present technology corresponds to the image processing apparatus according to the first of the present technology.

According to the first embodiment of the present technology, it is possible to calculate a pixel value of a luminance component of a pixel of interest that is a pixel attracting attention in a predetermined low-noise image corresponding to a predetermined image of a Bayer array, by a calculation of a predictive coefficient for a luminance component learned by solving a formula representing a relation between a pixel value of a luminance component of each pixel of a teacher image corresponding to a low-noise image which is an image including pixel values of a luminance component and a chrominance component of each pixel of the image of the Bayer array and an image having a reduced noise and the predictive coefficient for the luminance component, and a luminance prediction tap that includes a pixel value of a pixel of the predetermined image of the Bayer array using the teacher image, which corresponds to the pixel of interest, and a student image corresponding to the image of the Bayer array, and calculate a pixel value of a chrominance component of the pixel of interest by a calculation of a predictive coefficient for a chrominance component which is learned by solving a formula representing a relation among a pixel value of a chrominance component of each pixel of the teacher image, a pixel value of a pixel of the student image corresponding to the pixel, and the predictive coefficient for the chrominance component and a chrominance prediction tap that corresponds to the pixel of interest in the predetermined low-noise image and includes a pixel value of a pixel of the predetermined image of the Bayer array and is higher in noise reduction effect than the predictive coefficient for the luminance component using the teacher image and the student image.

According to a second embodiment of the present technology, there is provided a learning apparatus, including a learning unit that calculates a predictive coefficient used for converting a predetermined image of a Bayer array into a predetermined low-noise image which is an image including pixel values of a luminance component and a chrominance component of each pixel of the predetermined image of the Bayer array and an image having a reduced noise by solving a formula representing a relation among a pixel value of each pixel of a teacher image which is used for learning of the predictive coefficient and corresponds to the predetermined low-noise image, a prediction tap of the pixel, and the predictive coefficient using the prediction tap that corresponds to a pixel of interest which is a pixel attracting attention in the teacher image and includes a pixel value of a pixel of a student image corresponding to the predetermined image of the Bayer array and the pixel value of the pixel of interest.

The predictive coefficient for the luminance component and the predictive coefficient for the chrominance component are learned so that a degree of noise reduction in the chrominance component of the output image can be larger than a degree of noise reduction in the luminance component.

According to the second embodiment of the present technology, it is possible to calculate a predictive coefficient used for converting a predetermined image of a Bayer array into a predetermined low-noise image which is an image including pixel values of a luminance component and a chrominance component of each pixel of the predetermined image of the Bayer array and an image having a reduced noise by solving a formula representing a relation among a pixel value of each pixel of a teacher image which is used for learning of the predictive coefficient and corresponds to the predetermined low-noise image, a prediction tap of the pixel, and the predictive coefficient using the prediction tap that corresponds to a pixel of interest which is a pixel attracting attention in the teacher image and includes a pixel value of a pixel of a student image corresponding to the predetermined image of the Bayer array and the pixel value of the pixel of interest.

According to an embodiment of the present technology, a low-noise YUV image can be generated from an image of a Bayer array with a high degree of accuracy.

Further, according to another embodiment of the present technology, it is possible to learn a predictive coefficient used for generating a low-noise YUV image from an image of a Bayer array with a high degree of accuracy.

### BRIEF DESCRIPTION OF THE DRAWINGS

FIG. 1 is a diagram illustrating an example of a Bayer array;

FIG. 2 is a block diagram illustrating an exemplary configuration of an image processing apparatus of a related art;

FIG. 3 is a block diagram illustrating another exemplary configuration of an image processing apparatus of a related art;

FIG. 4 is a block diagram illustrating an exemplary configuration of an image processing apparatus according to an embodiment of the present technology;

FIG. 5 is a block diagram illustrating a detailed configuration example of a predictive signal processing unit;

FIG. 6 is a diagram illustrating an example of a tap structure of a class tap;

FIG. 7 is a diagram illustrating an example of a tap structure of a prediction tap;

FIG. 8 is a flowchart for explaining image processing of an image processing apparatus;

FIG. 9 is a flowchart for explaining the details of a class classification adaptive process for a luminance component;

FIG. 10 is a block diagram illustrating an exemplary configuration of a learning apparatus;

FIG. 11 is a flowchart for explaining a learning process of a learning apparatus; and

FIG. 12 is a diagram illustrating an exemplary configuration of a computer according to an embodiment.

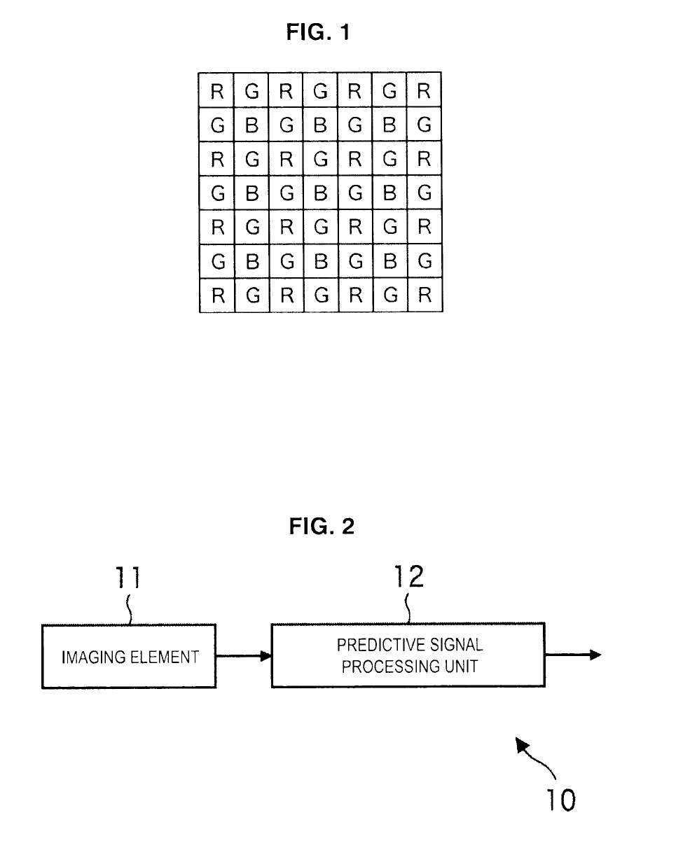

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

### Embodiments

[Exemplary Configuration of Image Processing Apparatus According to Embodiment]

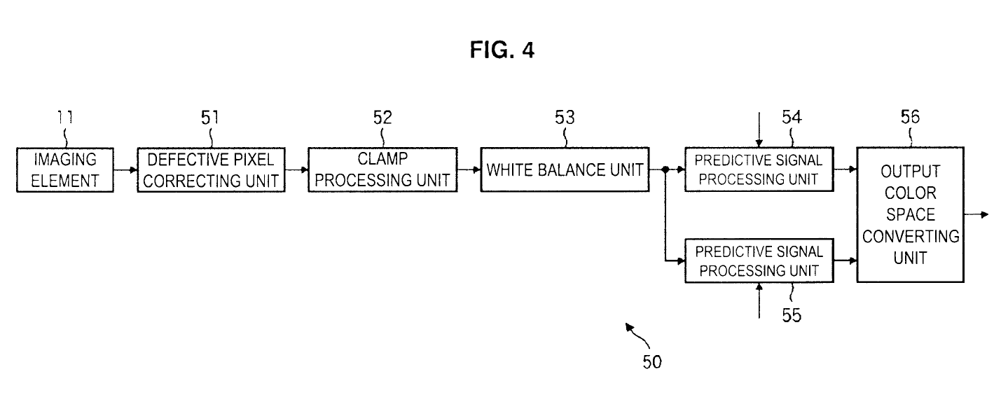

FIG. 4 is a block diagram illustrating an exemplary configuration of an image processing apparatus according to an embodiment of the present technology.

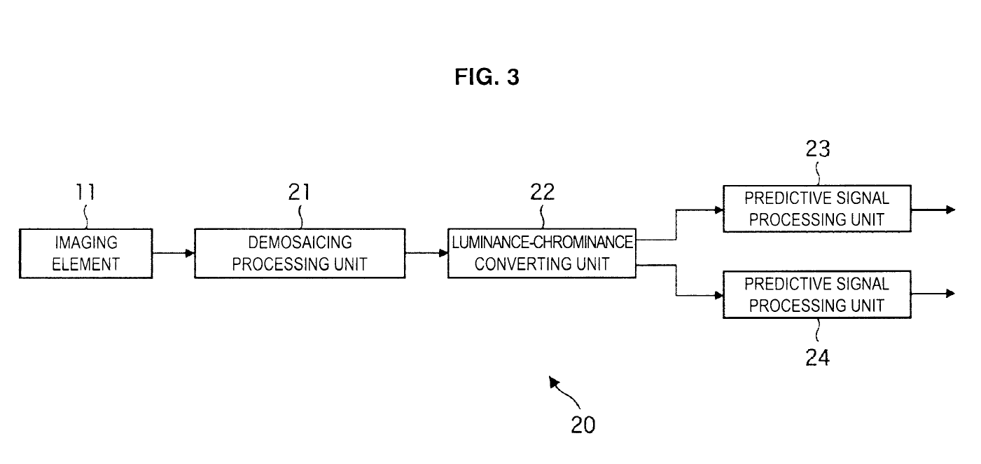

In FIG. 4, the same components as in FIG. 3 are denoted by the same reference numerals. The redundant description thereof will be appropriately omitted.

The image processing apparatus 50 of FIG. 4 includes an imaging element 11, a defective pixel correcting unit 51, a clamp processing unit 52, a white balance unit 53, a predictive signal processing unit 54, a predictive signal processing unit 55, and an output color space converting unit 56. The image processing apparatus 50 directly generates a low-noise YUV image from an image of a Bayer array using the class classification adaptive process.

The defective pixel correcting unit 51, the clamp processing unit 52, and the white balance unit 53 of the image processing apparatus 50 perform pre-processing on the image of the Bayer array generated by the imaging element 11 in order to increase the quality of the output image.

Specifically, the defective pixel correcting unit 51 detects a pixel value of a defective pixel in the imaging element 11 from the image of the Bayer array supplied from the imaging element 11. The defective pixel in the imaging element 11 refers to an element that does not respond to incident light or an element in which charges always remain accumulated for whatever reason. The defective pixel correcting unit 51 corrects the detected pixel value of the defective pixel in the imaging element 11, for example, using a pixel value of a non-defective pixel therearound, and supplies the corrected image of the Bayer array to the clamp processing unit 52.

The clamp processing unit 52 clamps the corrected image of the Bayer array supplied from the defective pixel correcting unit 51. Specifically, in order to prevent a negative value from being deleted, the imaging element 11 shifts a signal value of an analog signal in a positive direction, and then performs AD conversion. Thus, the clamp processing unit 52 clamps the corrected image of the Bayer array so that a shifted portion at the time of AD conversion can be negated. The clamp processing unit 52 supplies the clamped image of the Bayer array to the white balance unit 53.

The white balance unit 53 adjusts white balance by correcting gains of color components of the image of the Bayer array supplied from the clamp processing unit 52. The white balance unit 53 supplies the image of the Bayer array whose white balance has been adjusted to the predictive signal processing unit 54 and the predictive signal processing unit 55.

The predictive signal processing unit 54 performs the class classification adaptive process for the luminance component on the image of the Bayer array supplied from the white balance unit 53 based on a noise parameter representing a degree of noise reduction designated by a user, and generates a luminance component of the low-noise YUV image. The predictive signal processing unit 54 supplies the luminance component of the low-noise YUV image to the output color space converting unit 56.

The predictive signal processing unit 55 performs the class classification adaptive process for the chrominance component on the image of the Bayer array supplied from the white balance unit 53 based on a noise parameter representing a degree of noise reduction designated by the user, and generates a chrominance component of the low-noise YUV image. The predictive signal processing unit 55 supplies the chrominance component of the low-noise YUV image to the output color space converting unit 56.

The output color space converting unit 56 converts the YUV image including the luminance component from the predictive signal processing unit 54 and the chrominance component from the predictive signal processing unit 55 into an image of a YUV image or an RGB image selected by the user in advance, and outputs the converted image as the output image.

Specifically, when the image selected by the user is the YUV image, the output color space converting unit 56 outputs the YUV image including the luminance component from the predictive signal processing unit 54 and the chrominance component from the predictive signal processing unit 55 “as is” as the output image. However, when the image selected by the user is the RGB image, the output color space converting unit 56 converts the YUV image including the luminance component from the predictive signal processing unit 54 and the chrominance component from the predictive signal processing unit 55 into an RGB image that conforms to ITU-RBT.601 or the like. Then, the output color space converting unit 56 outputs the converted RGB image as the output image.

[Detailed Configuration Example of Predictive Signal Processing Unit]

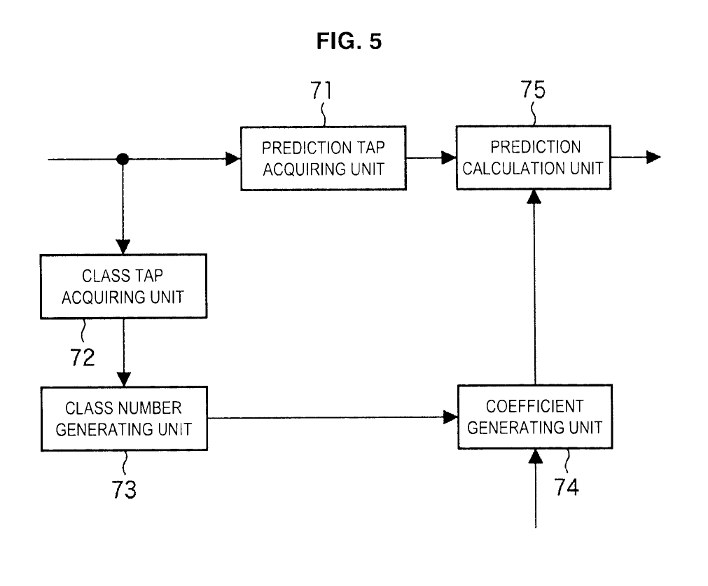

FIG. 5 is a block diagram illustrating a detailed configuration example of the predictive signal processing unit 54 illustrated in FIG. 54.

The predictive signal processing unit 54 of FIG. 5 includes a prediction tap acquiring unit 71, a class tap acquiring unit 72, a class number generating unit 73, a coefficient generating unit 74, and a prediction calculation unit 75.

The prediction tap acquiring unit 71 of the predictive signal processing unit 54 sequentially sets each of pixels of a low-noise YUV image to be predicted as a pixel of interest. The prediction tap acquiring unit 71 acquires one or more pixel values used for predicting a pixel value of a luminance component of a pixel of interest from the image of the Bayer array supplied from the white balance unit 53 illustrated in FIG. 4 as the prediction tap. Then, the prediction tap acquiring unit 71 supplies the prediction tap to the prediction calculation unit 75.

The class tap acquiring unit 72 acquires one or more pixel values used for performing class classification for classifying a pixel value of a luminance component of a pixel of interest into any one of one or more classes from the image of the Bayer array supplied from the white balance unit 53 as the class tap. Then, the class tap acquiring unit 72 supplies the class tap to the class number generating unit 73.

The class number generating unit 73 functions as a luminance class classifying unit, and performs class classification on a pixel value of the luminance component of the pixel of interest based on the class tap of each color component supplied from the class tap acquiring unit 72. The class number generating unit 73 generates a class number corresponding to a class obtained as the result, and supplies the generated class number to the coefficient generating unit 74.

For example, a method using adaptive dynamic range coding (ADRC) may be employed as a method of performing the class classification.

When the method using the ADRC is employed as the method of performing the class classification, a pixel value configuring the class tap is subjected to the ADRC process, and a class number of a pixel of interest is decided according to a re-quantization code obtained as the result.

Specifically, a process of equally dividing a value between a maximum value MAX and a minimum value MIN of the class tap by a designated bit number p and re-quantizing the division result by the following Formula (1) is performed as the ADRC process.

qi=[(ki−MIN+0.5)*2̂p/DR] (1)

In Formula (1), [ ] means that a number after the decimal point of a value in [ ] is truncated. Further, kᵢ represents an i-th pixel value of the class tap, and qᵢ represents a re-quantization code of the i-th pixel value of the class tap. Further, DR represents a dynamic range and is “MAX-MIN+1.”

Then, a class number class of a pixel of interest is calculated as in the following Formula (2) using the re-quantization code qᵢ obtained as described above.

$$\begin{matrix}[ Math . 1 ] & \\ class = {\sum }_{i = 1}^{n} {{q}_{i} ( {2}^{p} )}^{i - 1} & ( 2 )\end{matrix}$$

In Formula (2), n represents the number of pixel values configuring the class tap.

In addition to the method using the ADRC, a method of using an amount of data compressed by applying a data compression technique such as a discrete cosine transform (DCT), a vector quantization (VQ), or differential pulse code modulation (DPCM) as a class number may be used as the method of performing the class classification.

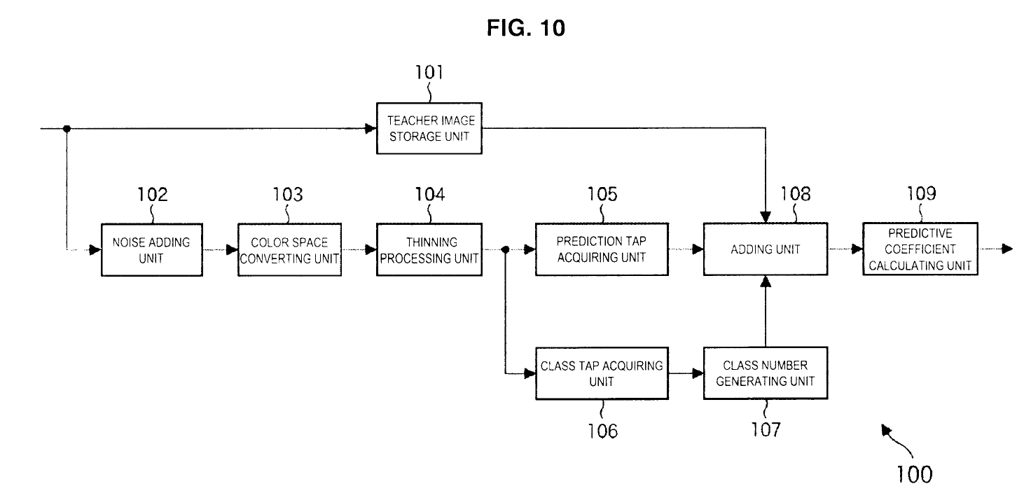

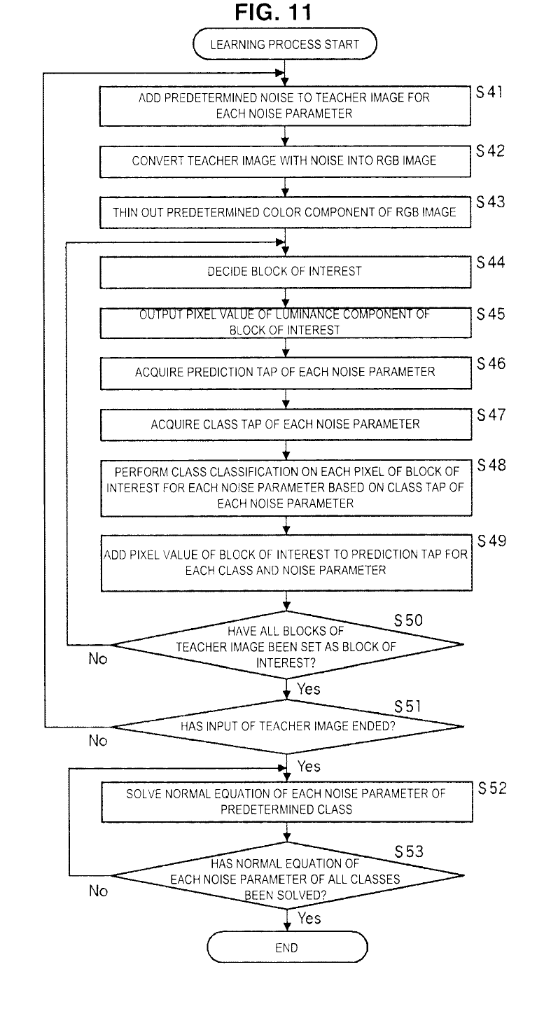

The coefficient generating unit 74 stores the predictive coefficient for the luminance component of each class and noise parameter obtained by a learning process which will be described later with reference to FIGS. 10 and 11. The coefficient generating unit 74 reads the predictive coefficient for the luminance component corresponding to a class corresponding to the class number from the class number generating unit 73 and a noise parameter designated by the user among the stored predictive coefficient for the luminance component, and supplies the read predictive coefficient for the luminance component to the prediction calculation unit 75.

The prediction calculation unit 75 performs a predetermined prediction calculation for calculating a prediction value of a true value of a pixel value of a luminance component of a pixel of interest using the prediction tap supplied from the prediction tap acquiring unit 71 and the predictive coefficient for the luminance component supplied from the coefficient generating unit 74. As a result, the prediction calculation unit 75 generates a prediction value of a pixel value of a luminance component of a pixel of interest as a pixel value of a luminance component of a pixel of interest of a low-noise YUV image, and outputs the prediction value.

The predictive signal processing unit 55 has the same configuration as the predictive signal processing unit 54, and thus a description thereof will be omitted. The predictive coefficient stored in the predictive signal processing unit 55 is not the predictive coefficient for the luminance component but the predictive coefficient for the chrominance component having a stronger noise reduction effect. The predictive coefficients for the chrominance components are a coefficient for a Cb component and a coefficient for a Cr component and so may be the same as or different from each other.

In the present embodiment, the predictive signal processing unit 54 and the predictive signal processing unit 55 employ the same class classification method but may employ different class classification methods.

[Example of Tap Structure of Class Tap]

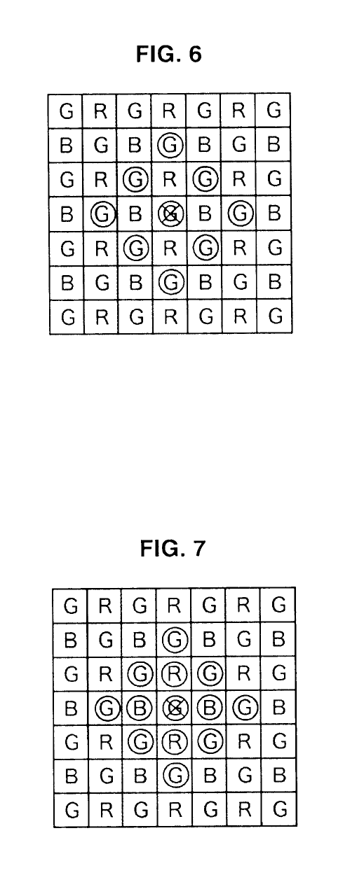

FIG. 6 is a diagram illustrating an example of a tap structure of the class tap. The class tap may have a tap structure other than a structure illustrated in FIG. 6.

In FIG. 6, a square represents each of pixels of an image of a Bayer array, and R, G, and B in squares represent that pixel values of pixels represented by corresponding squares are pixel values of an R component, a G component, and a B component, respectively. Further, an x mark represents that a pixel represented by a square with the x mark is a pixel (hereinafter, referred to a “corresponding pixel of interest”) at the same position, in an image of a Bayer array, as the position of a pixel of interest in a YUV image. A circle mark represents that a pixel represented by a square with the circle mark is a pixel corresponding to a class tap of a pixel of interest.

In the example of FIG. 6, pixel values of a total of 9 pixels including a total of 5 pixels at which one pixel is arranged centering on a corresponding pixel of interest in a horizontal direction and a vertical direction, respectively, and a total of 4 pixels adjacent to the corresponding pixel of interest in diagonal directions are regarded as the class tap. In this case, a color component corresponding to each pixel value of the class tap is identical to a color component corresponding to a corresponding pixel of interest. That is, in the example of FIG. 6, since a color component corresponding to the corresponding pixel of interest is a G component, a color component corresponding to each pixel of the class tap is also a G component.

[Example of Tap Structure of Prediction Tap]

FIG. 7 is a diagram illustrating an example of a tap structure of the prediction tap. The prediction tap may have a tap structure other than a structure of FIG. 7.

In FIG. 7, a square represents each pixel of an image of a Bayer array, and R, G, and B in squares represent that pixel values of pixels represented by corresponding squares are pixel values of an R component, a G component, and a B component, respectively. Further, an x mark represents that a pixel represented by a square with the x mark is a corresponding pixel of interest, and a circle mark represents that a pixel represented by a square with the circle mark is a pixel corresponding to a prediction tap of a pixel of interest.

In the example of FIG. 7, pixel values of a total of 13 pixels including a total of 9 pixels arranged such that 5 pixels are arranged centering on a corresponding pixel of interest in a horizontal direction and a vertical direction, respectively and a total of 4 adjacent pixels arranged above and below two adjacent pixel at the right and left sides of the corresponding pixel of interest are regarded as the prediction tap. That is, pixels corresponding to pixel values configuring the prediction tap are arranged in a diamond form.

In the present embodiment, the predictive signal processing unit 54 and the predictive signal processing unit 55 employ the class tap and the prediction tap of the same structure but may employ the class tap and the prediction tap of the different structures.

[Description of Prediction Calculation]

Next, a description will be made in connection with a prediction calculation in the prediction calculation unit 75 of FIG. 5 and learning of a predictive coefficient used for a luminance component for the prediction calculation.

For example, when a linear first-order prediction calculation is employed as a predetermined prediction calculation, a pixel value y of each color component of each pixel of a low-noise YUV image is obtained by the following linear first-order Formula.

$$\begin{matrix}[ Math . 2 ] & \\ y = {\sum }_{i = 1}^{n} {W}_{i} {x}_{i} & ( 3 )\end{matrix}$$

In Formula (3), xᵢ represents an i-th pixel value among pixel values configuring the prediction tap on a pixel value y, and Wᵢ represents an i-th predictive coefficient for a luminance component which is multiplied by the i-th pixel value. Further, n represents the number of pixel values configuring the prediction tap.

Further, when yₖ′ represents a prediction value of a pixel value of luminance component of a pixel of a low-noise YUV image of a k-th sample, the prediction value yk′ is represented by the following Formula (4).

yₖ′=W₁×xₖ₁+W₂×xₖ₂+ - - - Wₙ×xₖₙ (4)

In Formula (4), xₖᵢ represents an i-th pixel value among pixel values configuring the prediction tap on a true value of the prediction value yₖ′, and Wᵢ represents an i-th predictive coefficient for a luminance component which is multiplied by the i-th pixel value. Further, n represents the number of pixel values configuring the prediction tap.

Further, when yₖ represents a true value of the prediction value yₖ′, a prediction error eₖ is represented by the following Formula (5).

eₖ=yₖ−{W₁×xₖ₁+W₂×xₖ₂+ . . . +Wₙ×xₖₙ} (5)

In FIG. 5, xₖᵢ represents an i-th pixel value among pixel values configuring the prediction tap on a true value of the prediction value yₖ′, and Wᵢ represents an i-th predictive coefficient for a luminance component which is multiplied by the i-th pixel value. Further, n represents the number of pixel values configuring the prediction tap.

The predictive coefficient Wᵢ for a luminance component that causes the prediction error eₖ of Formula (5) to become zero (0) is optimum for prediction of the true value yₖ, but when the number of samples for learning is smaller than n, the predictive coefficient Wᵢ for a luminance component is not uniquely decided.

In this regard, for example, when the least-square method is employed as a norm representing that the predictive coefficient Wᵢ for a luminance component is optimum, the optimum predictive coefficient Wᵢ for a luminance component can be obtained by minimizing a sum E of square errors represented by the following Formula (6).

$$\begin{matrix}[ Math . 3 ] & \\ E = {\sum }_{k = 1}^{m} {e}_{k}^{2} & ( 6 )\end{matrix}$$

A minimum value of the sum E of the square errors of Formula (6) is given by Wᵢ for a luminance component that causes a value, obtained by differentiating the sum E by the predictive coefficient Wᵢ to become zero (0) as in the following Formula (7).

$$\begin{matrix}[ Math . 4 ] & \\ \frac{\partial E}{\partial {W}_{i}} = {\sum }_{k = 1}^{m} 2 ( \frac{\partial {e}_{k}}{\partial {W}_{i}} ) {e}_{k} = {\sum }_{k = 1}^{m} 2 \times {k}_{i} \cdot {e}_{k} = 0 & ( 7 )\end{matrix}$$

When Xⱼᵢ and Yᵢ are defined as in the following Formulas (8) and (9), Formula (7) can be represented in the form of a determinant as in the following Formula (10).

$$\begin{matrix}[ Math . 5 ] & \\ {X}_{ji} = {\sum }_{k = 1}^{m} {x}_{ki} \times {x}_{kj} & ( 8 ) \\ [ Math . 6 ] & \\ {Y}_{i} = {\sum }_{k = 1}^{m} {x}_{ki} \times {y}_{k} & ( 9 ) \\ [ Math . 7 ] & \\ ( \begin{matrix}{x}_{11} & {x}_{12} & … & {x}_{1 n} \\ {x}_{21} & {x}_{22} & … & {x}_{2 n} \\ ⋮ & ⋮ & ⋮ & ⋮ \\ {x}_{n 1} & {x}_{n 2} & … & {x}_{nn}\end{matrix} ) ( \begin{matrix}{W}_{1} \\ {W}_{2} \\ ⋮ \\ {W}_{n}\end{matrix} ) = ( \begin{matrix}{Y}_{1} \\ {Y}_{2} \\ ⋮ \\ {Y}_{n}\end{matrix} ) & ( 10 )\end{matrix}$$

In Formulas (8) to (10), xₖᵢ represents an i-th pixel value among pixel values configuring the prediction tap on the true value yₖ of the prediction value yₖ′, and Wᵢ represents an i-th predictive coefficient for a luminance component which is multiplied by the i-th pixel value. Further, n represents the number of pixel values configuring the prediction tap, and m represents the number of samples for learning.

For example, a normal equation of Formula (10) can obtain a solution to the predictive coefficient Wᵢ for a luminance component using a general matrix solution such as a sweep-out method (Gauss-Jordan's Elimination method).

As a result, learning of the optimum predictive coefficient Wᵢ for a luminance component of each class and noise parameter can be performed by solving the normal equation of Formula (10) for each class and noise parameter.

The pixel value y can be obtained by a high-order formula of a second-order or higher rather than a linear first-order formula illustrated in Formula (3).

Even though not described, a prediction calculation in the predictive signal processing unit 55 of FIG. 4 and learning of a predictive coefficient for a chrominance component of each class and noise parameter used for the prediction calculation are performed in the same manner as a prediction calculation in the prediction calculation unit 75 of FIG. 5 and learning of a predictive coefficient for a luminance component of each class and noise parameter used for the prediction calculation.

[Description of Processing of Image Processing Apparatus]

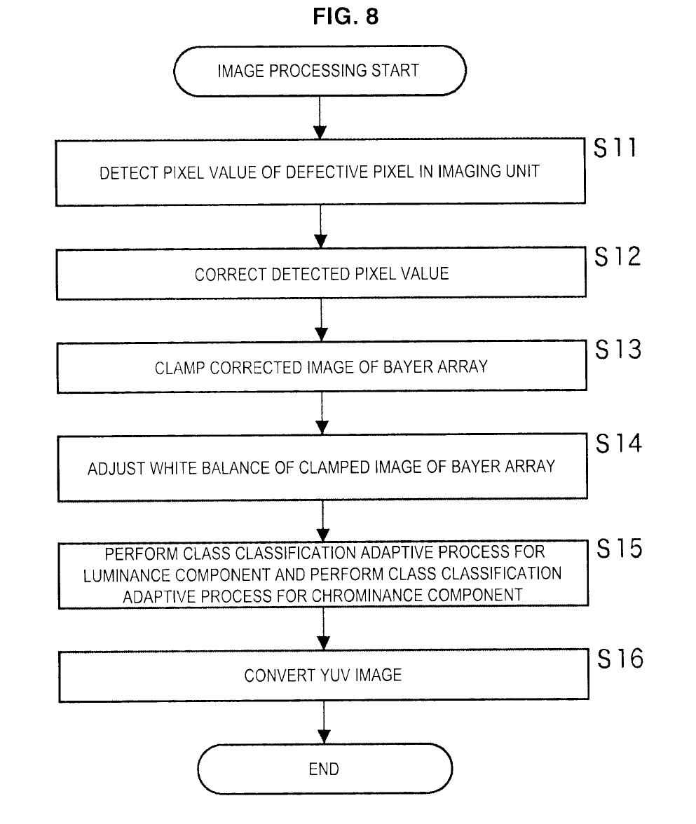

FIG. 8 is a flowchart for explaining image processing of the image processing apparatus 50 according to the second embodiment. For example, the image processing starts when the image of the Bayer array is supplied from the imaging element 11.

Referring to FIG. 8, in step S11, the defective pixel correcting unit 51 of the image processing apparatus 50 detects a pixel value of a defective pixel in the imaging element 11 from the image of the Bayer array supplied from the imaging element 11 of FIG. 3.

In step S12, the defective pixel correcting unit 51 corrects the detected pixel value of the defective pixel in the imaging element 11 detected in step S11, for example, using a pixel value of a non-defective pixel therearound, and supplies the corrected image of the Bayer array to the clamp processing unit 52.

In step S13, the clamp processing unit 52 clamps the corrected image of the Bayer array supplied from the defective pixel correcting unit 51. The clamp processing unit 52 supplies the clamped image of the Bayer array to the white balance unit 53.

In step S14, the white balance unit 53 adjusts white balance by correcting gains of color components of the clamped image of the Bayer array supplied from the clamp processing unit 52. The white balance unit 53 supplies the image of the Bayer array whose white balance has been adjusted to the predictive signal processing unit 54 and the predictive signal processing unit 55.

In step S15, the predictive signal processing unit 54 performs the class classification adaptive process for the luminance component, and the predictive signal processing unit 55 performs the class classification adaptive process for the chrominance component. The predictive signal processing unit 54 supplies the luminance component of the low-noise YUV image obtained as the result of the class classification adaptive process for the luminance component to the output color space converting unit 56. Further, the predictive signal processing unit 55 supplies the chrominance component of the low-noise YUV image obtained as the result of the class classification adaptive process for the chrominance component to the output color space converting unit 56.

In step S16, the output color space converting unit 56 converts the YUV image including the luminance component from the predictive signal processing unit 54 and the chrominance component from the predictive signal processing unit 55 into an image of a YUV image or an RGB image selected by the user in advance. The output color space converting unit 56 outputs the converted image as the output image and ends the process.

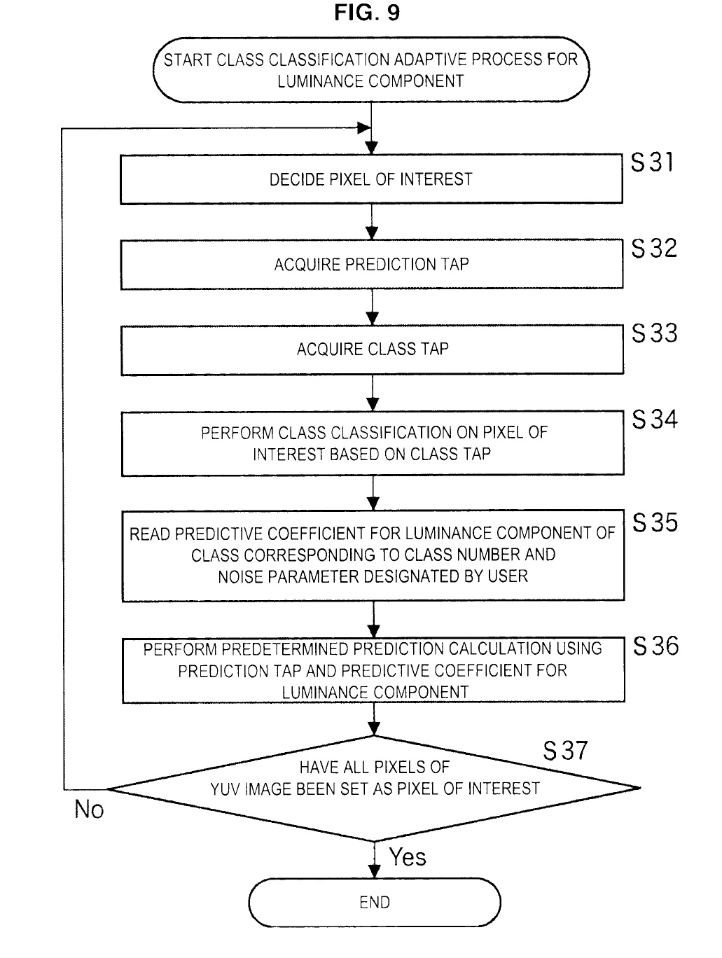

FIG. 9 is a flowchart for explaining the details of the class classification adaptive process for the luminance component of step S15 in FIG. 8.

Referring to FIG. 9, in step S31, the prediction tap acquiring unit 71 of the predictive signal processing unit 54 decides a pixel that has not been set as a pixel of interest among pixels of a low-noise YUV image to be predicted as a pixel of interest.

In step S32, the prediction tap acquiring unit 71 acquires one or more pixel values used for predicting a pixel value of a luminance component of a pixel of interest from the image of the Bayer array supplied from the white balance unit 53 illustrated in FIG. 4 as the prediction tap. Then, the prediction tap acquiring unit 71 supplies the prediction tap to the prediction calculation unit 75.

In step S33, the class tap acquiring unit 72 acquires one or more pixel values used for performing class classification on a pixel value of a luminance component of a pixel of interest from the image of the Bayer array supplied from the white balance unit 53 as the class tap. Then, the class tap acquiring unit 72 supplies the class tap to the class number generating unit 73.

In step S34, the class number generating unit 73 performs class classification on a pixel value of a luminance component of a pixel of interest based on the lass tap supplied from the class tap acquiring unit 72. The class number generating unit 73 generates a class number corresponding to a class obtained as the result, and supplies the class number to the coefficient generating unit 74.

In step S35, the coefficient generating unit 74 reads the predictive coefficient for the luminance component corresponding to a class corresponding to the class number supplied from the class number generating unit 73 and a noise parameter designated by the user among the stored predictive coefficient for the luminance component. Then, the coefficient generating unit 74 supplies the read predictive coefficient to the prediction calculation unit 75.

In step S36, the prediction calculation unit 75 performs a calculation of Formula (3) as a predetermined prediction calculation using the prediction tap supplied from the prediction tap acquiring unit 71 and the predictive coefficient for the luminance component supplied from the coefficient generating unit 74. As a result, the prediction calculation unit 75 generates a prediction value of a pixel value of a luminance component of a pixel of interest as a pixel value of a luminance component of a pixel of interest of a low-noise YUV image, and outputs the prediction value.

In step S37, the prediction tap acquiring unit 71 determines whether or not all pixels of the low-noise YUV image have been set as a pixel of interest. When it is determined in step S37 that all pixels of the low-noise YUV image have not been set as a pixel of interest yet, the process returns to step S31, and the processes of steps S31 to S37 are repeated until all pixels of the low-noise YUV image are set as a pixel of interest.

However, when it is determined in step S37 that all pixels of the low-noise YUV image have been set as a pixel of interest, the process ends.

The class classification adaptive process for the chrominance component of step S15 in FIG. 8 is the same as the class classification adaptive process for the luminance component of FIG. 9 except that the predictive coefficient for the chrominance component is used instead of the predictive coefficient for the luminance component. Thus, a description thereof will be omitted.

As described above, the image processing apparatus 50 performs a predetermined prediction calculation using the predictive coefficient for the luminance component and a predetermined prediction calculation using the predictive coefficient for the chrominance component having a noise reduction effect higher than the predictive coefficient for the luminance component on the image of the Bayer array Thus, the image processing apparatus 50 can directly generate a low-color noise YUV image without any reduction in sharpness from the image of the Bayer array. Thus, compared to the image processing apparatus 20 (FIG. 3) of the related art that generates a low-noise YUV image through processing of three times, since a low-noise YUV image is not generated using a first processing result or the like that may change the fine line portion, an edge of a color, or the like, a low-noise YUV image can be generated with a high degree of accuracy.

Further, compared to the image processing apparatus 20 of the related art, degradation in the accuracy of the YUV image can be prevented since it is unnecessary to temporarily store the first or second processing result.

Specifically, in the image processing apparatus 20 of the related art, since the low-noise YUV image is generated through processing of three times, it is necessary to accumulate an RGB image which is the first processing result in a memory (not shown) by a pixel used for generating one pixel of the YUV image at least in the second processing. Similarly, it is necessary to accumulate the YUV image which is the second processing result in a memory (not shown) by a pixel used for generating one pixel of the low-noise YUV image at least in the third processing. Since the capacity of the memory is realistically finite, there is a case in which a bit number of a pixel value of each pixel of an RGB image which is the first processing result or a YUV image which is the second processing result needs to be reduced. In this case, the accuracy of the low-noise YUV image degrades.

On the other hand, the image processing apparatus 50 directly generates the low-noise YUV image from the image of the Bayer array and so needs not store the interim result of the process. Accordingly, degradation in the accuracy of the low-noise YUV image can be prevented.

In addition, the image processing apparatus 50 includes two blocks to perform the class classification adaptive process, that is, a block for the luminance component and a block for the chrominance component. Thus, compared to when each of the demosaicing processing unit 21 and the luminance-chrominance converting unit 22 of FIG. 3 includes a block for performing the class classification adaptive process, that is, when the image processing apparatus 50 includes 4 blocks to perform the class classification adaptive process, the circuit size can be reduced.

[Exemplary Configuration of Learning Apparatus]

FIG. 10 is a block diagram illustrating an exemplary configuration of a learning apparatus 100 that learns the predictive coefficient Wᵢ for the luminance component stored in the coefficient generating unit 74 of FIG. 5.

The learning apparatus 100 of FIG. 10 includes a teacher image storage unit 101, a noise adding unit 102, a color space converting unit 103, a thinning processing unit 104, a prediction tap acquiring unit 105, a class tap acquiring unit 106, a class number generating unit 107, an adding unit 108, and a predictive coefficient calculating unit 109.

A teacher image is input the learning apparatus 100 as a learning image used for learning of the predictive coefficient Wᵢ for the luminance component. Here, an ideal YUV image generated by the enlargement prediction processing unit 54 of FIG. 5, i.e., a low-noise YUV image of a high accuracy is used as the teacher image.

The teacher image storage unit 101 stores the teacher image. The teacher image storage unit 101 divides the stored teacher image into blocks each including a plurality of pixels, and sequentially sets each block as a block of interest. The teacher image storage unit 101 supplies a pixel value of a luminance component of a block of interest to the adding unit 108.

The noise adding unit 102 adds a predetermined noise having a different noise amount according to each noise parameter to the teacher image, and supplies the teacher image with the noise of each noise parameter to the color space converting unit 103.

The color space converting unit 103 converts the teacher image with the noise of each noise parameter supplied from the noise adding unit 102 into an RGB image, and supplies the converted RGB image to the thinning processing unit 104.

The thinning processing unit 104 thins out a pixel value of a predetermined color component among pixel values of color components of the RGB image of each noise parameter supplied from the color space converting unit 103 according to a Bayer array, and generates an image of a Bayer array of each noise parameter. Further, the color space converting unit 103 performs a filter process corresponding to a process of an optical low pass filter (not shown) included in the imaging element 11 on the generated image of the Bayer array of each noise parameter. Thus, it is possible to generate the image of the Bayer array approximated by the image of the Bayer array generated by the imaging element 11. The color space converting unit 103 supplies the image of the Bayer array of each noise parameter that has been subjected to the filter process to the prediction tap acquiring unit 105 and the class tap acquiring unit 106 as a student image of each noise parameter corresponding to the teacher image.

The prediction tap acquiring unit 105 sequentially sets each of pixels of a block of interest as a pixel of interest. The prediction tap acquiring unit 105 acquires one or more pixel values used for predicting a pixel value of a luminance component of a pixel of interest from the student image of each noise parameter supplied from the thinning processing unit 104 as the prediction tap, similarly to the prediction tap acquiring unit 71 of FIG. 5. Then, the prediction tap acquiring unit 105 supplies the prediction tap of each pixel of a block of interest of each noise parameter to the adding unit 108.

The class tap acquiring unit 106 acquires one or more pixel values used for performing class classification on a pixel value of a luminance component of a pixel of interest from the student image of each noise parameter supplied from the thinning processing unit 104 as the class tap, similarly to the class tap acquiring unit 72 of FIG. 5. Then, the class tap acquiring unit 106 supplies the class tap of each pixel of a block of interest of each noise parameter to the class number generating unit 107.

The class number generating unit 107 functions as a class classifying unit. The class number generating unit 107 performs class classification on a pixel value of a luminance component of each pixel of a block of interest for each noise parameter based on the class tap of each pixel of a block of interest of each noise parameter supplied from the class tap acquiring unit 106, similarly to the class number generating unit 73 of FIG. 5. The class number generating unit 107 generates a class number corresponding to a class of a pixel value of a luminance component of each pixel of a block of interest of each noise parameter obtained as the result, and supplies the generated class number to the adding unit 108.

The adding unit 108 adds the pixel value of the block of interest from the teacher image storage unit 101 to the prediction tap of the block of interest of each noise parameter from the prediction tap acquiring unit 105 for each noise parameter and each class of the class number from the class number generating unit 107.

Specifically, the adding unit 108 calculates Xᵢⱼ in a matrix at the left side of Formula (10) for each class and noise parameter using xₖᵢ and xₖⱼ (i,j=1, 2, - - - , n) as the pixel value of each pixel of the prediction tap of each pixel of the block of interest.

Further, the adding unit 108 sets a pixel value of each pixel of a block of interest to yₖ, and calculates Yᵢ in a matrix at the right side of Formula (10) for each class and noise parameter using the pixel value xₖᵢ.

Then, the adding unit 108 supplies the normal equation of Formula (10) of each class and noise parameter, which is generated by performing the addition process using all blocks of all teacher images as the block of interest, to the predictive coefficient calculating unit 109.

The predictive coefficient calculating unit 109 functions as a learning unit, calculates the optimum predictive coefficient Wᵢ for the luminance component for each class and noise parameter by solving the normal equation of each class and noise parameter supplied from the adding unit 108, and outputs the calculated optimum predictive coefficient Wᵢ for the luminance component. The optimum predictive coefficient Wᵢ for the luminance component of each class and noise parameter is stored in the coefficient generating unit 74 of FIG. 5.

[Description of Processing of Learning Apparatus]

FIG. 11 is a flowchart for explaining a learning process of the learning apparatus 100 of FIG. 10. For example, the learning process starts when an input of the teacher image starts.

Referring to FIG. 11, in step S41, the noise adding unit 102 of the learning apparatus 100 adds a predetermined noise having a different noise amount according to each noise parameter to the teacher image, and supplies the teacher image with the noise of each noise parameter to the color space converting unit 103.

In step S42, the color space converting unit 103 converts the teacher image with the noise of each noise parameter supplied from the noise adding unit 102 into an RGB image, and supplies the converted RGB image to the thinning processing unit 104.

In step S43, the thinning processing unit 104 thins out a pixel value of a predetermined color component among pixel values of color components of the RGB image of each noise parameter supplied from the color space converting unit 103 according to a Bayer array, and generates an image of a Bayer array of each noise parameter. Further, the color space converting unit 103 performs a filter process corresponding to a process of an optical low pass filter (not shown) included in the imaging element 11 on the generated image of the Bayer array of each noise parameter. The color space converting unit 103 supplies the image of the Bayer array of each noise parameter that has been subjected to the filter process to the prediction tap acquiring unit 105 and the class tap acquiring unit 106 as a student image of each noise parameter corresponding to the teacher image.

In step S44, the teacher image storage unit 101 stores the input teacher image, divides the stored teacher image into blocks each including a plurality of pixels, and decides a block that has not been set as a block of interest yet among the blocks as a block of interest.

In step S45, the teacher image storage unit 101 reads a stored pixel value of a luminance component of a block of interest, and supplies the read pixel value to the adding unit 108.

In step S46, the prediction tap acquiring unit 105 acquires the prediction tap of each pixel of a block of interest of each noise parameter from the student image of each noise parameter supplied from the thinning processing unit 104. Then, the prediction tap acquiring unit 105 supplies the prediction tap of each pixel of a block of interest of each noise parameter to the adding unit 108.

In step S47, the class tap acquiring unit 106 acquires the class tap of each pixel of a block of interest of each noise parameter from the student image of each noise parameter supplied from the thinning processing unit 104. Then, the class tap acquiring unit 106 supplies the class tap of each pixel of a block of interest of each noise parameter to the class number generating unit 107.

In step S48, the class number generating unit 107 performs class classification on a pixel value of a luminance component of each pixel of a block of interest for each noise parameter based on the class tap of each pixel of a block of interest of each noise parameter supplied from the class tap acquiring unit 106. The class number generating unit 107 generates a class number corresponding to a class of a pixel value of a luminance component of each pixel of a block of interest of each noise parameter obtained as the result, and supplies the generated class number to the adding unit 108.

In step S49, the adding unit 108 adds the pixel value of the block of interest from the teacher image storage unit 101 to the prediction tap of each noise parameter of the block of interest from the prediction tap acquiring unit 105 for each class of the class number from the class number generating unit 107 and noise parameter.

In step S50, the adding unit 108 determines whether or not all blocks of the teacher image have been set as the block of interest. When it is determined in step S50 that not all blocks of the teacher image have been set as the block of interest yet, the process returns to step S44, and the processes of steps S44 to S50 are repeated until all blocks are set as the block of interest.

However, when it is determined in step S50 that all blocks of the teacher image have been set as the block of interest, the process proceeds to step S51. In step S51, the adding unit 108 determines whether or not an input of the teacher image has ended, that is, whether or not there are no longer any new teacher images being input to the learning apparatus 100.

When it is determined in step S51 that an input of the teacher image has not ended, that is, when it is determined that a new teacher image is input to the learning apparatus 100, the process returns to step S41, and the processes of steps S41 to S51 are repeated until new teacher images are no longer input.

However, when it is determined in step S51 that an input of the teacher image has ended, that is, when it is determined that that new teacher images are no longer input to the learning apparatus 100, the adding unit 108 supplies the normal equation of Formula (10) of each class and noise parameter, which is generated by performing the addition process in step S49, to the predictive coefficient calculation unit 109.

Then, in step S52, the predictive coefficient calculation unit 109 solves the normal equation of Formula (10) of each noise parameter of a predetermined class among normal equations of Formula (10) of each class and noise parameter supplied from the adding unit 108. As a result, the predictive coefficient calculation unit 109 calculates the optimum predictive coefficient Wᵢ for each noise parameter of the predetermined class, and outputs the calculated optimum predictive coefficient Wᵢ for the luminance component.

In step S53, the predictive coefficient calculation unit 109 determines whether or not the normal equation of Formula (10) of each noise parameter of all classes has been solved. When it is determined in step S53 that the normal equations of Formula (10) of respective noise parameters have not been solved for all classes, the process returns to step S52, and the predictive coefficient calculation unit 109 solves the normal equation of Formula (10) of each noise parameter of a class which has not been solved and then performs the process of step S53.

However, when it is determined in step S53 that the normal equations of Formula (10) of respective noise parameters of all classes have been solved, the process ends.

As described above, the learning apparatus 100 generates the prediction tap of each pixel of a block of interest of a teacher image from a student image including a predetermined noise, and obtains the predictive coefficient for the luminance component by solving the normal equation using the pixel value of each pixel of the block of interest and the prediction tap. Thus, the learning apparatus 100 can learn the predictive coefficient for generating the luminance component of the low-noise YUV image with a high degree of accuracy in the predictive signal processing unit 54 of FIG. 4.

Further, since the learning apparatus 100 changes a noise amount of a noise included in the student image for each noise parameter, the user can select a degree of noise reduction in the predictive signal processing unit 54 of FIG. 4 by designating the noise parameter.

Further, even though not shown, a learning apparatus that learns the predictive coefficient for the chrominance component has the same configuration as the learning apparatus 100 and performs the same process. However, a noise amount of a noise of each noise parameter added by a noise adding unit of the learning apparatus that learns the predictive coefficient for the chrominance component is larger than a noise amount of each noise parameter added by the noise adding unit 102. Thus, the predictive coefficient for the chrominance component has the noise reduction effect higher than the predictive coefficient for the luminance component.

Further, the learning apparatus 100 performs the addition process for each block of interest but may perform the addition process for each pixel of interest using each pixel of the teacher image as the pixel of interest.

Further, the predictive coefficient for the luminance component and the predictive coefficient for the chrominance component may be obtained by a learning apparatus that employs a neural network (NN) or a support vector machine (SVM) using a student image and a teacher image.

Furthermore, in the above description, an image of a Bayer array is generated by the imaging element 11, but an array of each color component of an image generated by the imaging element 11 may not be the Bayer array.

[Description of Computer According to Present Technology]

Next, a series of processes described above may be performed by hardware or software. When a series of processes is performed by software, a program configuring the software is installed in a general-purpose computer or the like.

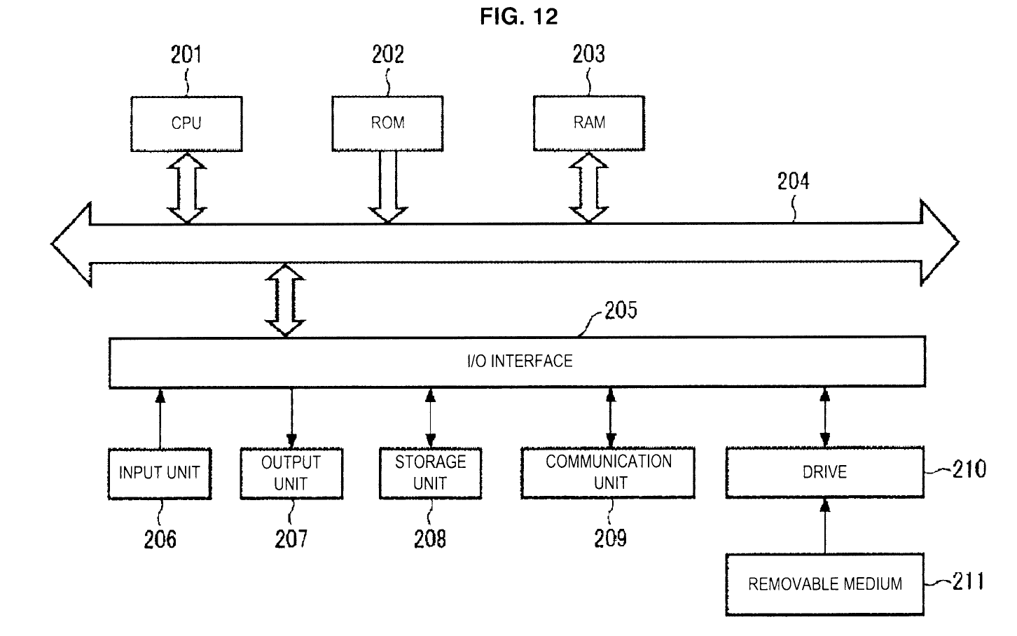

FIG. 12 illustrates an exemplary configuration of a computer in which a program for executing a series of processes described above is installed.

The program may be recorded in a storage unit 208 or a read only memory (ROM) 202 functioning as a storage medium built in the computer in advance.

Alternatively, the program may be stored (recorded) in a removable medium 211. The removable medium 211 may be provided as so-called package software. Examples of the removable medium 211 include a flexible disk, a compact disc read only memory (CD-ROM), a magneto optical (MO) disc, a digital versatile disc (DVD), a magnetic disk, and a semiconductor memory.

Further, the program may be installed in the computer from the removable medium 211 through a drive 210. Furthermore, the program may be downloaded to the computer via a communication network or a broadcast network and then installed in the built-in storage unit 208. In other words, for example, the program may be transmitted from a download site to the computer through a satellite for digital satellite broadcasting in a wireless manner, or may be transmitted to the computer via a network such as a local area network (LAN) or the Internet in a wired manner.

The computer includes a central processing unit (CPU) 201 therein, and an I/O interface 205 is connected to the CPU 201 via a bus 204.

When the user operates an input unit 206 and an instruction is input via the I/O interface 205, the CPU 201 executes the program stored in the ROM 202 in response to the instruction. Alternatively, the CPU 201 may load the program stored in the storage unit 208 to a random access memory (RAM) 203 and then execute the loaded program.

In this way, the CPU 201 performs the processes according to the above-described flowcharts, or the processes performed by the configurations of the above-described block diagrams. Then, the CPU 201 outputs the processing result from an output unit 207, or transmits the processing result from a communication unit 209, for example, through the I/O interface 205, as necessary. Further, the CPU 201 records the processing result in the storage unit 208.

The input unit 206 is configured with a keyboard, a mouse, a microphone, and the like. The output unit 207 is configured with a liquid crystal display (LCD), a speaker, and the like.

In the present disclosure, a process which a computer performs according to a program need not necessarily be performed in time series in the order described in the flowcharts. In other words, a process which a computer performs according to a program also includes a process which is executed in parallel or individually (for example, a parallel process or a process by an object).

Further, a program may be processed by a single computer (processor) or may be distributedly processed by a plurality of computers. Furthermore, a program may be transmitted to a computer at a remote site and then executed.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1)

An image processing apparatus, including:

a luminance prediction calculation unit that calculates a pixel value of a luminance component of a pixel of interest that is a pixel attracting attention in a predetermined low-noise image corresponding to a predetermined image of a Bayer array; by a calculation of a predictive coefficient for a luminance component learned by solving a formula representing a relation between a pixel value of a luminance component of each pixel of a teacher image corresponding to a low-noise image which is an image including pixel values of a luminance component and a chrominance component of each pixel of the image of the Bayer array and an image having a reduced noise and the predictive coefficient for the luminance component, and a luminance prediction tap that includes a pixel value of a pixel of the predetermined image of the Bayer array using the teacher image, which corresponds to the pixel of interest, and a student image corresponding to the image of the Bayer array; and

a chrominance prediction calculation unit that calculates a pixel value of a chrominance component of the pixel of interest by a calculation of a predictive coefficient for a chrominance component which is learned by solving a formula representing a relation among a pixel value of a chrominance component of each pixel of the teacher image, a pixel value of a pixel of the student image corresponding to the pixel, and the predictive coefficient for the chrominance component and a chrominance prediction tap that corresponds to the pixel of interest in the predetermined low-noise image and includes a pixel value of a pixel of the predetermined image of the Bayer array and is higher in noise reduction effect than the predictive coefficient for the luminance component using the teacher image and the student image.

(2)

The image processing apparatus according to (1),

wherein the predictive coefficient for the luminance component and the predictive coefficient for the chrominance component are learned for each noise parameter representing a degree of noise reduction in the predetermined low-noise image,

the luminance prediction calculation unit calculates the pixel value of the luminance component of the pixel interest by a calculation of the predictive coefficient for the luminance component and the luminance prediction tap of the predetermined noise parameter based on the predetermined noise parameter, and

the chrominance prediction calculation unit calculates the pixel value of the chrominance component of the pixel interest by a calculation of the predictive coefficient for the chrominance component and the chrominance prediction tap of the predetermined noise parameter based on the predetermined noise parameter.

(3)

The image processing apparatus according to (1) or (2), further including:

a luminance prediction tap acquiring unit that acquires the luminance prediction tap from the predetermined image of the Bayer array; and

a chrominance prediction tap acquiring unit that acquires the chrominance prediction tap from the predetermined image of the Bayer array.

(4)

The image processing apparatus according to any one of (1) to (3), further including:

a luminance class tap acquiring unit that acquires a pixel value of a pixel of the predetermined image of the Bayer array corresponding to the pixel of interest as a luminance class tap used for performing class classification for classifying a pixel value of a luminance component of the pixel of interest into any one of a plurality of classes;

a luminance class classifying unit that classifies a pixel value of a luminance component of the pixel of interest based on the luminance class tap acquired by the luminance class tap acquiring unit;

a chrominance class tap acquiring unit that acquires a pixel value of a pixel of the predetermined image of the Bayer array corresponding to the pixel of interest as a chrominance class tap used for performing class classification on a pixel value of a chrominance component of the pixel of interest; and

a chrominance class classifying unit that classifies a pixel value of a chrominance component of the pixel of interest based on the chrominance class tap acquired by the chrominance class tap acquiring unit,

wherein the predictive coefficient for the luminance component and the predictive coefficient for the chrominance component are learned for each class,

the luminance prediction calculation unit calculates a pixel value of a luminance component of the pixel of interest by a calculation of the predictive coefficient for the luminance component corresponding to a class of a pixel value of a luminance component of the pixel of interest obtained as a result of class classification by the luminance class classifying unit and the luminance prediction tap, and

the chrominance prediction calculation unit calculates a pixel value of a chrominance component of the pixel of interest by a calculation of the predictive coefficient for the chrominance component corresponding to a class of a pixel value of a chrominance component of the pixel of interest obtained as a result of class classification by the chrominance class classifying unit and the chrominance prediction tap.

(5)

An image processing method, including:

at an image processing apparatus,

calculating a pixel value of a luminance component of a pixel of interest that is a pixel attracting attention in a predetermined low-noise image corresponding to a predetermined image of a Bayer array by a calculation of a predictive coefficient for a luminance component learned by solving a formula representing a relation between a pixel value of a luminance component of each pixel of a teacher image corresponding to a low-noise image which is an image including pixel values of a luminance component and a chrominance component of each pixel of the image of the Bayer array and an image having a reduced noise and the predictive coefficient for the luminance component, and a luminance prediction tap that includes a pixel value of a pixel of the predetermined image of the Bayer array, which corresponds to the pixel of interest, using the teacher image and a student image corresponding to the image of the Bayer array; and

calculating a pixel value of a chrominance component of the pixel of interest by a calculation of a predictive coefficient for a chrominance component which is learned by solving a formula representing a relation among a pixel value of a chrominance component of each pixel of the teacher image, a pixel value of a pixel of the student image corresponding to the pixel, and the predictive coefficient for the chrominance component and a chrominance prediction tap that corresponds to the pixel of interest in the predetermined low-noise image and includes a pixel value of a pixel of the predetermined image of the Bayer array and is higher in noise reduction effect than the predictive coefficient for the luminance component using the teacher image and the student image.

(6)

A program for causing a computer to execute:

calculating a pixel value of a luminance component of a pixel of interest that is a pixel attracting attention in a predetermined low-noise image corresponding to a predetermined image of a Bayer array by a calculation of a predictive coefficient for a luminance component learned by solving a formula representing a relation between a pixel value of a luminance component of each pixel of a teacher image corresponding to a low-noise image which is an image including pixel values of a luminance component and a chrominance component of each pixel of the image of the Bayer array and an image having a reduced noise and the predictive coefficient for the luminance component, and a luminance prediction tap that includes a pixel value of a pixel of the predetermined image of the Bayer array, which corresponds to the pixel of interest, using the teacher image and a student image corresponding to the image of the Bayer array; and

calculating a pixel value of a chrominance component of the pixel of interest by a calculation of a predictive coefficient for a chrominance component which is learned by solving a formula representing a relation among a pixel value of a chrominance component of each pixel of the teacher image, a pixel value of a pixel of the student image corresponding to the pixel, and the predictive coefficient for the chrominance component and a chrominance prediction tap that corresponds to the pixel of interest in the predetermined low-noise image and includes a pixel value of a pixel of the predetermined image of the Bayer array and is higher in noise reduction effect than the predictive coefficient for the luminance component using the teacher image and the student image.

(7)

A recording medium recording the program recited in (6).

(8)

A learning apparatus, including:

a learning unit that calculates a predictive coefficient used for converting a predetermined image of a Bayer array into a predetermined low-noise image which is an image including pixel values of a luminance component and a chrominance component of each pixel of the predetermined image of the Bayer array and an image having a reduced noise by solving a formula representing a relation among a pixel value of each pixel of a teacher image which is used for learning of the predictive coefficient and corresponds to the predetermined low-noise image, a prediction tap of the pixel, and the predictive coefficient using the prediction tap that corresponds to a pixel of interest which is a pixel attracting attention in the teacher image and includes a pixel value of a pixel of a student image corresponding to the predetermined image of the Bayer array and the pixel value of the pixel of interest.

(9)

The learning apparatus according to (8), further including:

a noise adding unit that adds a predetermined noise to the teacher image;

a color space converting unit that converts the teacher image to which the predetermined noise is added by the noise adding unit into a color image including pixel values of a plurality of predetermined color components of each pixel of the teacher image; and

a thinning processing unit that thins out a pixel value of a predetermined color component among the pixel values of the plurality of color components of each pixel of the color image converted by the color space converting unit, and sets an image of a Bayer array obtained as the result as the student image.

(10)

The learning apparatus according to (9),

wherein the noise adding unit adds the predetermined noise corresponding to a noise parameter representing a degree of noise reduction in the predetermined low-noise image for each noise parameter, and

the learning unit calculates the predictive coefficient for each noise parameter by solving the formula using the prediction tap including a pixel value of a pixel that configures the student image corresponding to the noise parameter and corresponds to the pixel of interest and the pixel value of the pixel of interest for each noise parameter.

(11)

The learning apparatus according to any one of (8) to (10), further including

a prediction tap that acquires the prediction tap from the student image.

(12)

The learning apparatus according to any one of (8) to (11), further including:

a class tap acquiring unit that acquires a pixel value of a pixel of the student image corresponding to the pixel of interest as a class tap used for performing class classification for classifying the pixel of interest into any one of a plurality of classes; and

a class classifying unit that performs class classification on the pixel of interest based on the class tap acquired by the class tap acquiring unit,

wherein the learning unit calculates a predictive coefficient of each class by solving the formula for each class of the pixel of interest using the pixel value of the pixel of interest and the prediction tap.

(13)

A learning method, including:

at a learning apparatus,

calculating a predictive coefficient used for converting a predetermined image of a Bayer array into a predetermined low-noise image which is an image including pixel values of a luminance component and a chrominance component of each pixel of the predetermined image of the Bayer array and an image having a reduced noise by solving a formula representing a relation among a pixel value of each pixel of a teacher image which is used for learning of the predictive coefficient and corresponds to the predetermined low-noise image, a prediction tap of the pixel, and the predictive coefficient using the prediction tap that corresponds to a pixel of interest which is a pixel attracting attention in the teacher image and includes a pixel value of a pixel of a student image corresponding to the predetermined image of the Bayer array and the pixel value of the pixel of interest.

(14)

A program for causing a computer to execute:

calculating a predictive coefficient used for converting a predetermined image of a Bayer array into a predetermined low-noise image which is an image including pixel values of a luminance component and a chrominance component of each pixel of the predetermined image of the Bayer array and an image having a reduced noise by solving a formula representing a relation among a pixel value of each pixel of a teacher image which is used for learning of the predictive coefficient and corresponds to the predetermined low-noise image, a prediction tap of the pixel, and the predictive coefficient using the prediction tap that corresponds to a pixel of interest which is a pixel attracting attention in the teacher image and includes a pixel value of a pixel of a student image corresponding to the predetermined image of the Bayer array and the pixel value of the pixel of interest.

(15)

A recording medium recording the program recited in (14).

The present disclosure contains subject matter related to that disclosed in Japanese Priority Patent Application JP 2011-113059 filed in the Japan Patent Office on May 20, 2011, the entire content of which is hereby incorporated by reference.

What is claimed is:

1. An image processing apparatus, comprising:
a luminance prediction calculation unit that calculates a pixel value of a luminance component of a pixel of interest that is a pixel attracting attention in a predetermined low-noise image corresponding to a predetermined image of a Bayer array;
by a calculation of a predictive coefficient for a luminance component learned by solving a formula representing a relation between a pixel value of a luminance component of each pixel of a teacher image corresponding to a low-noise image which is an image including pixel values of a luminance component and a chrominance component of each pixel of the image of the Bayer array and an image having a reduced noise and the predictive coefficient for the luminance component, and a luminance prediction tap that includes a pixel value of a pixel of the predetermined image of the Bayer array using the teacher image, which corresponds to the pixel of interest, and a student image corresponding to the image of the Bayer array; and
a chrominance prediction calculation unit that calculates a pixel value of a chrominance component of the pixel of interest by a calculation of a predictive coefficient for a chrominance component which is learned by solving a formula representing a relation among a pixel value of a chrominance component of each pixel of the teacher image, a pixel value of a pixel of the student image corresponding to the pixel, and the predictive coefficient for the chrominance component and a chrominance prediction tap that corresponds to the pixel of interest in the predetermined low-noise image and includes a pixel value of a pixel of the predetermined image of the Bayer array and is higher in noise reduction effect than the predictive coefficient for the luminance component using the teacher image and the student image.

2. The image processing apparatus according to claim 1,
wherein the predictive coefficient for the luminance component and the predictive coefficient for the chrominance component are learned for each noise parameter representing a degree of noise reduction in the predetermined low-noise image,
the luminance prediction calculation unit calculates the pixel value of the luminance component of the pixel interest by a calculation of the predictive coefficient for the luminance component and the luminance prediction tap of the predetermined noise parameter based on the predetermined noise parameter, and
the chrominance prediction calculation unit calculates the pixel value of the chrominance component of the pixel interest by a calculation of the predictive coefficient for the chrominance component and the chrominance prediction tap of the predetermined noise parameter based on the predetermined noise parameter.

3. The image processing apparatus according to claim 1, further comprising:
a luminance prediction tap acquiring unit that acquires the luminance prediction tap from the predetermined image of the Bayer array; and
a chrominance prediction tap acquiring unit that acquires the chrominance prediction tap from the predetermined image of the Bayer array.

4. The image processing apparatus according to claim 1, further comprising:
a luminance class tap acquiring unit that acquires a pixel value of a pixel of the predetermined image of the Bayer array corresponding to the pixel of interest as a luminance class tap used for performing class classification for classifying a pixel value of a luminance component of the pixel of interest into any one of a plurality of classes;
a luminance class classifying unit that classifies a pixel value of a luminance component of the pixel of interest based on the luminance class tap acquired by the luminance class tap acquiring unit;
a chrominance class tap acquiring unit that acquires a pixel value of a pixel of the predetermined image of the Bayer array corresponding to the pixel of interest as a chrominance class tap used for performing class classification on a pixel value of a chrominance component of the pixel of interest; and
a chrominance class classifying unit that classifies a pixel value of a chrominance component of the pixel of interest based on the chrominance class tap acquired by the chrominance class tap acquiring unit,
wherein the predictive coefficient for the luminance component and the predictive coefficient for the chrominance component are learned for each class,
the luminance prediction calculation unit calculates a pixel value of a luminance component of the pixel of interest by a calculation of the predictive coefficient for the luminance component corresponding to a class of a pixel value of a luminance component of the pixel of interest obtained as a result of class classification by the luminance class classifying unit and the luminance prediction tap, and
the chrominance prediction calculation unit calculates a pixel value of a chrominance component of the pixel of interest by a calculation of the predictive coefficient for the chrominance component corresponding to a class of a pixel value of a chrominance component of the pixel of interest obtained as a result of class classification by the chrominance class classifying unit and the chrominance prediction tap.

5. An image processing method, comprising:
at an image processing apparatus,
calculating a pixel value of a luminance component of a pixel of interest that is a pixel attracting attention in a predetermined low-noise image corresponding to a predetermined image of a Bayer array by a calculation of a predictive coefficient for a luminance component learned by solving a formula representing a relation between a pixel value of a luminance component of each pixel of a teacher image corresponding to a low-noise image which is an image including pixel values of a luminance component and a chrominance component of each pixel of the image of the Bayer array and an image having a reduced noise and the predictive coefficient for the luminance component, and a luminance prediction tap that includes a pixel value of a pixel of the predetermined image of the Bayer array, which corresponds to the pixel of interest, using the teacher image and a student image corresponding to the image of the Bayer array; and
calculating a pixel value of a chrominance component of the pixel of interest by a calculation of a predictive coefficient for a chrominance component which is learned by solving a formula representing a relation among a pixel value of a chrominance component of each pixel of the teacher image, a pixel value of a pixel of the student image corresponding to the pixel, and the predictive coefficient for the chrominance component and a chrominance prediction tap that corresponds to the pixel of interest in the predetermined low-noise image and includes a pixel value of a pixel of the predetermined image of the Bayer array and is higher in noise reduction effect than the predictive coefficient for the luminance component using the teacher image and the student image.

6. A program for causing a computer to execute:
calculating a pixel value of a luminance component of a pixel of interest that is a pixel attracting attention in a predetermined low-noise image corresponding to a predetermined image of a Bayer array by a calculation of a predictive coefficient for a luminance component learned by solving a formula representing a relation between a pixel value of a luminance component of each pixel of a teacher image corresponding to a low-noise image which is an image including pixel values of a luminance component and a chrominance component of each pixel of the image of the Bayer array and an image having a reduced noise and the predictive coefficient for the luminance component, and a luminance prediction tap that includes a pixel value of a pixel of the predetermined image of the Bayer array, which corresponds to the pixel of interest, using the teacher image and a student image corresponding to the image of the Bayer array; and
calculating a pixel value of a chrominance component of the pixel of interest by a calculation of a predictive coefficient for a chrominance component which is learned by solving a formula representing a relation among a pixel value of a chrominance component of each pixel of the teacher image, a pixel value of a pixel of the student image corresponding to the pixel, and the predictive coefficient for the chrominance component and a chrominance prediction tap that corresponds to the pixel of interest in the predetermined low-noise image and includes a pixel value of a pixel of the predetermined image of the Bayer array and is higher in noise reduction effect than the predictive coefficient for the luminance component using the teacher image and the student image.

7. A recording medium recording the program recited in claim 6.

8. A learning apparatus, comprising:
a learning unit that calculates a predictive coefficient used for converting a predetermined image of a Bayer array into a predetermined low-noise image which is an image including pixel values of a luminance component and a chrominance component of each pixel of the predetermined image of the Bayer array and an image having a reduced noise by solving a formula representing a relation among a pixel value of each pixel of a teacher image which is used for learning of the predictive coefficient and corresponds to the predetermined low-noise image, a prediction tap of the pixel, and the predictive coefficient using the prediction tap that corresponds to a pixel of interest which is a pixel attracting attention in the teacher image and includes a pixel value of a pixel of a student image corresponding to the predetermined image of the Bayer array and the pixel value of the pixel of interest.

9. The learning apparatus according to claim 8, further comprising:
a noise adding unit that adds a predetermined noise to the teacher image;
a color space converting unit that converts the teacher image to which the predetermined noise is added by the noise adding unit into a color image including pixel values of a plurality of predetermined color components of each pixel of the teacher image; and
a thinning processing unit that thins out a pixel value of a predetermined color component among the pixel values of the plurality of color components of each pixel of the color image converted by the color space converting unit, and sets an image of a Bayer array obtained as the result as the student image.

10. The learning apparatus according to claim 9,
wherein the noise adding unit adds the predetermined noise corresponding to a noise parameter representing a degree of noise reduction in the predetermined low-noise image for each noise parameter, and
the learning unit calculates the predictive coefficient for each noise parameter by solving the formula using the prediction tap including a pixel value of a pixel that configures the student image corresponding to the noise parameter and corresponds to the pixel of interest and the pixel value of the pixel of interest for each noise parameter.

11. The learning apparatus according to claim 8, further comprising
a prediction tap that acquires the prediction tap from the student image.

12. The learning apparatus according to claim 8, further comprising:
a class tap acquiring unit that acquires a pixel value of a pixel of the student image corresponding to the pixel of interest as a class tap used for performing class classification for classifying the pixel of interest into any one of a plurality of classes; and
a class classifying unit that performs class classification on the pixel of interest based on the class tap acquired by the class tap acquiring unit,
wherein the learning unit calculates a predictive coefficient of each class by solving the formula for each class of the pixel of interest using the pixel value of the pixel of interest and the prediction tap.

13. A learning method, comprising:
at a learning apparatus,
calculating a predictive coefficient used for converting a predetermined image of a Bayer array into a predetermined low-noise image which is an image including pixel values of a luminance component and a chrominance component of each pixel of the predetermined image of the Bayer array and an image having a reduced noise by solving a formula representing a relation among a pixel value of each pixel of a teacher image which is used for learning of the predictive coefficient and corresponds to the predetermined low-noise image, a prediction tap of the pixel, and the predictive coefficient using the prediction tap that corresponds to a pixel of interest which is a pixel attracting attention in the teacher image and includes a pixel value of a pixel of a student image corresponding to the predetermined image of the Bayer array and the pixel value of the pixel of interest.

14. A program for causing a computer to execute:
calculating a predictive coefficient used for converting a predetermined image of a Bayer array into a predetermined low-noise image which is an image including pixel values of a luminance component and a chrominance component of each pixel of the predetermined image of the Bayer array and an image having a reduced noise by solving a formula representing a relation among a pixel value of each pixel of a teacher image which is used for learning of the predictive coefficient and corresponds to the predetermined low-noise image, a prediction tap of the pixel, and the predictive coefficient using the prediction tap that corresponds to a pixel of interest which is a pixel attracting attention in the teacher image and includes a pixel value of a pixel of a student image corresponding to the predetermined image of the Bayer array and the pixel value of the pixel of interest.

15. A recording medium recording the program recited in claim 14.
